(19) United States
(12) Patent Application Publication
(10) Pub. No.: US 2020/0001239 A1
(43) Pub. Date: Jan. 2, 2020

(54) FLUID FILTRATION SYSTEM

(71) Applicant: Combined Separation Systems Pty Ltd., Victoria (AU)

(72) Inventor: Stephen Pereira, Victoria (AU)

(73) Assignee: Combined Separation Systems Pty Ltd., Victoria (AU)

(21) Appl. No.: 16/454,657

(22) Filed: Jun. 27, 2019

(30) Foreign Application Priority Data
Jun. 28, 2018 (AU) 2019902339

(51) Int. Cl. B01D 65/02; B01D 61/20; B01D 61/18

(52) U.S. Cl. CPC B01D 65/02; B01D 63/02; B01D 61/18; B01D 61/20

(57) ABSTRACT

Disclosed herein is a membrane filtration system comprising a supply tank for receiving a supply of raw fluid for filtration, a membrane filter at least partially submerged within the raw fluid; a suction line attachable to the membrane filter for drawing cleaned fluid from the membrane filter to a storage reservoir for storing the cleaned fluid; a pump for supplying a negative pressure to the suction line for delivering said cleaned fluid from the membrane filter to the storage reservoir; a bypass line connecting the suction line to the storage reservoir; and a pressure regulating valve located within said bypass line; wherein, upon the negative pressure present in the suction line reaching a predetermined level, the pressure regulating valve opens to connect the suction line with the storage reservoir.

### CROSS-REFERENCE TO RELATED APPLICATIONS

This application claims priority from Australian Provisional patent Application No. 2018902339 filed 28 Jun. 2018, the entire contents of which are incorporated herein by reference for all purposes.

### TECHNICAL FIELD

The present disclosure relates generally to a filtration system for processing fluid high in particulate matter and impurities, and in particular, to a system and method for controlling the operation of a membrane filtration system to control the fouling rate and to maximise filtration rates of the system.

### BACKGROUND

Water purifying and filtering systems utilising membrane technology are known. Such systems function through utilising the porous nature of the membranes to filter foreign materials (or scales) from a contaminated water source, thereby generating clean or purified water as a resultant product of the process. There exist various types of filtering systems available to achieve this purpose.

One type of technology that is particularly adapted for this purpose involves the use of hollow fibre membrane technology. In such a system, each membrane generally represents a hair-like fibre having a hollow core and porous walls. Source water, typically contaminated water with impurities contained therein, is drawn into the core of the membrane through the porous walls thereof, and is removed from either end of the membrane. The porosity of the membrane walls may be defined by holes formed therein, which may have a size of no greater than 0.05 microns, depending upon the filtration purpose.

Different filtration systems will have different flux rates. A flux rate is defined by the rate at which water can be drawn through the membrane. During usage, as water is drawn through the membrane and out of the filtration system, any particulate matter removed from the water that has been unable to pass through the membrane is left behind with the raw water supply. As such, over time, the raw water being filtered by the system becomes more concentrated in particulate matter and becomes harder to draw through the membrane. This condition will continue to occur until such time as the membrane becomes blocked and clean water is unable to be drawn from the system. Such a phenomenon is often referred to as the membrane becoming fouled, or fouling, which significantly decreases the flux rate of the system.

As fouling of membranes in water filtration is a common problem, a variety of solutions have been proposed to address this problem, with varying degrees of success. Some proposed methods include air agitation methods whereby air bubbles or the like are generated and directed towards the surface of the membrane to dislodge particulate matter therefrom. A problem with this is that the generation of air bubbles or turbulence in the water is an energy intensive process which can reduce the energy efficiency of the overall filtration system.

A variety of different pre-treatment systems upstream of the membrane filtration have been proposed to reduce the amount of particulate matter being presented to the membrane to reduce membrane fouling. However, such systems are typically costly to install and greatly increase the size and complexity of the filtration system. Chemical cleaning of the membrane is also an available option; however, due to high toxicity of the chemicals typically used, care needs to be taken in handling such chemicals and they release harmful vapours to the atmosphere. Providing excess replacement membranes to enable the fouled membranes to be removed from the system for cleaning is another way of addressing membrane fouling. However, due to the cost of replacement membranes and the downtime and skill required to replace the membranes within a system, such a solution adds significant cost and time to the filtration process which may make the process less cost effective.

For this reason the most common means for addressing the fouling of membranes in a submerged membrane filtration system is the use of backwashing cycles. This typical involves the previously filtered water being used to flush back into the filtration system at a high pressure, such that the previously filtered water is caused to pass back through the pores of the membrane and loosen any fouling particulate matter that may have deposited on the surfaces of the membrane, adjacent the pores. Such backwashing methods are effective in overcoming membrane fouling, but as the filtered water is used to backwash, repeated use of this water results in the production of the filtration system being significantly reduced. Further, to ensure that the components of the filtration system remain operating within acceptable limits, it is difficult to determine when a backwashing cycle should be initiated.

In each of the above referenced means for addressing membrane fouling, there is typically a sustained period whereby the pump is operating within very high pressure ranges. This also results in a significant over-pressurisation of the membrane which can significantly reduce the life of the membrane as well as the working life of the pump. It will be appreciated that over time, exposure to such high negative pressures will cause the membrane and the pump to fail, thereby requiring replacement. This is an expensive exercise and is to be avoided.

Thus, there is a need to provide a system for addressing fouling of the membranes in a submerged membrane filtration system that provides for minimal wastage of filtered water and which ensures that the system pressures are maintained within acceptable limits for as long as possible, to minimise wear and fatigue of the components of the system to maintain system efficiency.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present disclosure of which the identification of pertinent prior art proposals is but one part.

### SUMMARY

The disclosure according to one or more aspects is as defined in the independent claims. Some optional and/or preferred features of the disclosure are defined in the dependent claims.

Accordingly, in one aspect of the disclosure there is provided a membrane filtration system comprising:

a supply tank for receiving a supply of raw fluid for filtration;

a membrane filter at least partially submerged within the raw fluid;

a suction line attachable to the membrane filter for drawing cleaned fluid from the membrane filter to a storage reservoir for storing the cleaned fluid:

a pump for supplying a negative pressure to the suction line for delivering said cleaned fluid from the membrane filter to the storage reservoir;

a bypass line connecting the suction line to the storage reservoir; and

a pressure regulating valve located within said bypass line;

wherein, upon the negative pressure present in the suction line reaching a predetermined level, the pressure regulating valve opens to connect the suction line with the storage reservoir.

In another aspect, there is provided a membrane filtration system comprising:

a supply tank for receiving a supply of raw fluid for filtration;

a membrane filter at least partially submerged within the raw fluid:

a suction line attachable to the membrane filter for drawing cleaned fluid from the membrane filter to a storage reservoir for storing the cleaned fluid;

a pump for supplying a negative pressure to the suction line for delivering said cleaned fluid from the membrane filter to the storage reservoir;

wherein, the negative pressure present in the suction line is monitored and the pump is controllable to maintain the negative pressure within acceptable levels.

### BRIEF DESCRIPTION OF THE DRAWINGS

The disclosure may be better understood from the following non-limiting description of preferred embodiments, in which:

FIG. 1 is a membrane water filtration system in accordance with the present disclosure;

FIG. 2 is an alternative embodiment of a water filtration system in accordance with the present disclosure; and

FIG. 3 is a flow chart depicting a method of controlling a water filtration system in accordance with an embodiment of the present disclosure.

### DETAILED DESCRIPTION OF THE DRAWINGS

Preferred features of the present disclosure will now be described with particular reference to the accompanying drawings. However, it is to be understood that the features illustrated in and described with reference to the drawings are not to be construed as limiting on the scope of the disclosure.

The system and apparatus of the present disclosure will be described below in relation to its application for use in a water filtration system 10. However, it will be appreciated by those skilled in the art that the system and method may be employed in any fluid filtration environment where a contaminated fluid requires purification for filtration into a potable fluid form.

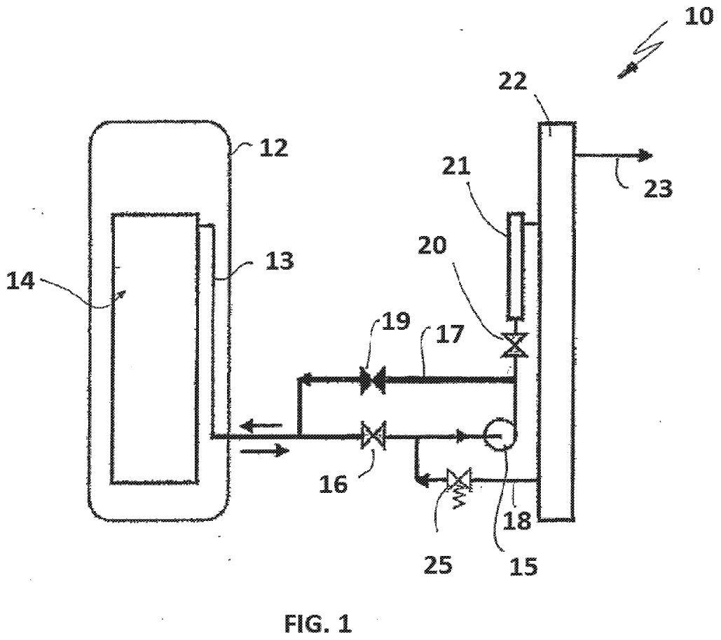

Referring to FIG. 1, a membrane water filtration system 10 is depicted having a raw water tank 12 for receiving raw water for filtration. The raw water may be taken from any variety of sources where the water contains a variety of contaminants that require removal therefrom for conversion into a potable water source or a water source for any other variety of uses, such as irrigation.

A membrane 14 is submerged within the raw water of the raw water tank 12. The membrane may take any variety of forms but, in a preferred embodiment, comprises a hollow fibre membrane made from Polyvinylidene difluoride (PVDF). Each membrane is hairlike and has a hollow core and porous walls whereby water is drawn through the walls of the membrane and is drawn from one end of the membrane. The holes in the membrane wall are no greater than 0.05 micron. It will be appreciated that other materials and configurations of the membrane are also envisaged.

The membrane 14 is substantially submerged in the raw water tank with the upper end thereof attached to a suction line 13 to draw cleaned water therefrom. A pump 15 provides the suction force to draw water from the membrane where it passes through a control valve 16 to be delivered into the cleaned water reservoir 22 to form a cleaned water source.

As previously discussed, this process of drawing clean water from the raw water tank 12 will continue with the pump 15 operating within acceptable pressure limits. As fouling of the membrane 14 occurs, the load on the pump 15 that is required to draw the fluid from the tank 12 increases. This causes in increase in negative pressure within the suction line 13.

The pump 15 will typically have a controller (not shown) associated therewith. The controller may be a computer controller and may comprise any of a number of computing devices known to those skilled in the art. The controller typically includes a central processing unit or CPU having one or more microprocessors and memory operably connected to the CPU. The memory can include any combination of random access memory (RAM), a storage medium such as a magnetic hard disk drive(s) and the like. The controller may also include one or more pressure sensors located within the suction line 13 for determining fluid pressure therein.

In normal operation of the filter system, during filtration the pump 15 operates at suction pressures of between −20 and −90 kPa, preferably around −75 kPa. When the negative pressure in the suction line 13 is determined by the controller to reach a predetermined level, in one embodiment the predetermined level may be around −75 kPa, the pressure regulating valve 25 in the bypass line 18 receives a signal from the controller to open thereby causing the cleaned water present in the cleaned water reservoir 22 to enter the suction line 13. As a result, the pump 15 will draw both cleaned water from the membrane 14 and cleaned water from the reservoir 22, and maintain a desired operating pressure of around −75 kPa. Rather than all the fluid being drawn from the raw water tank 12 via the membrane 14, some water will also be recirculated from the cleaned water reservoir 22 thereby reducing any excessive pressures being present on the membranes 14 and maximising the working life of the membranes 14. As the state of fouling of the membranes will continue to increase over time, more cleaned water from the cleaned water reservoir 22 will be drawn through the pump 15 via the bypass line 18 with the pump maintaining a relatively optimal operating pressure.

It will be appreciated that the predetermined pressure level may vary and will be determined by the optimal operating conditions of the pump and membranes to ensure that the pressure levels are minimised. The controller may be pre-set with the predetermined pressure level or may be programmed separately such that the predetermined pressure level can be altered as required, especially where different membranes and pump capacities are to be employed.

Prior to entering the cleaned water reservoir 22, the water is passed through a pre-treatment process 21. In a preferred form this pre-treatment process 21 may be a UV (ultra violet) disinfection process that exposes the water to UV radiation to kill any bacteria present in the water prior to storage in the cleaned water reservoir 22. It will be appreciated that as the cleaned water in the cleaned water reservoir 22 may be recirculated back through the pump in accordance with the present disclosure, the cleaned water may be subject to multiple UV purification processes.

The present disclosure is able to deal with membrane fouling in a manner that does not place the components in the system under stress due to high negative pressures. The membranes 14 can continue to foul in a conventional manner until a cleaning cycle is initiated, typically by way of a timing system, which may also be controlled by the controller. In this regard, after the controller has determined that a predetermined time of operation has passed, the pressure regulating valve 25 in the bypass line 18 may close together with the valve 16, and the valve 19 may open to connect the backwash line 17 to the membrane 14 to flush the particulate matter on the surface of the membrane 14 from the pores thereof, in a conventional manner.

Upon completion of this backwash cycle, the controller may open the valve 16 and close the valve 19, thereby causing the pump to generate a vacuum pressure in the suction line 13 to draw cleaned water from the raw water tank 12. Over time, the concentration of contaminants in the raw water tank 12 will increase to a level whereby the suction pressure generated by the pump 15 will increase to around −75 kPa. This will then cause the controller to open the pressure regulating valve 25, thereby opening the bypass line such that the pump 15 will draw fluid from both the raw water tank 12 and the cleaned water reservoir 22 at the predetermined pressure. This state will continue as the membranes continue to foul, until the next timed cleaning cycle.

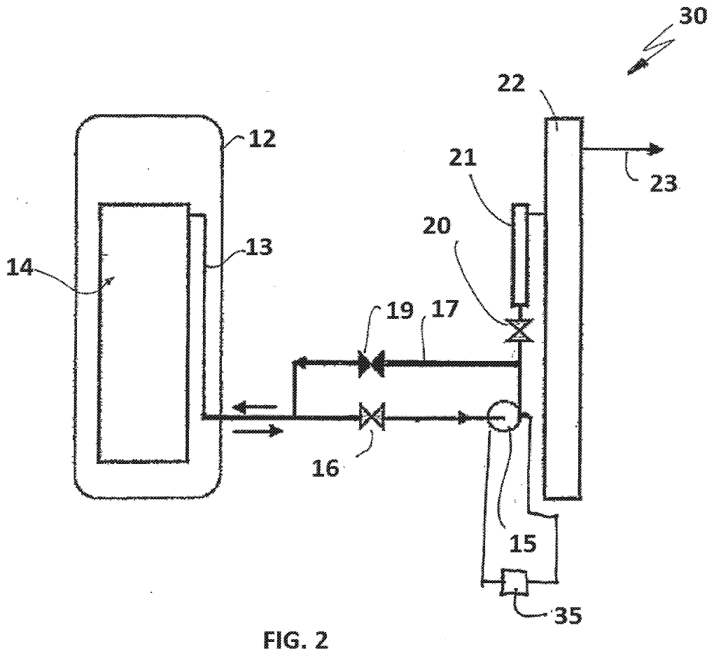

An alternative embodiment of a membrane water filtration system is depicted as reference numeral 30 in FIG. 2. This system 30 is similar to the system 10 depicted in FIG. 1, with the exception that instead of employing a pressure regulating valve 25 and bypass line 18 to regulate the pressure at the membrane, the flow rate of the pump 15 is controlled for this purpose.

A controller 35, such as that described above in relation to the first embodiment, is able to monitor the throughput of the pump 15 during the filtering process and the pressure at the membrane 14 can be monitored by means of a pressure sensor or the like (not shown), which feeds the sensed pressure level to the controller 35. The controller 35 is able to control the pump 15 by way of a variable speed drive or throttle provided in the outlet of the pump 15. This enables the controller 35 to monitor the pressure at the membrane 14 such that as the pressure at the membrane 14 increases due to fouling and begins to approach an upper pressure limit, the controller 35 is able to intervene to slow down the pump to maintain the pressure at the membrane 14 at an acceptable operating level. Should this pressure vary, the controller 35 is able to respond by ramping up the pump speed or slowing down the pump speed in response to changing membrane pressure.

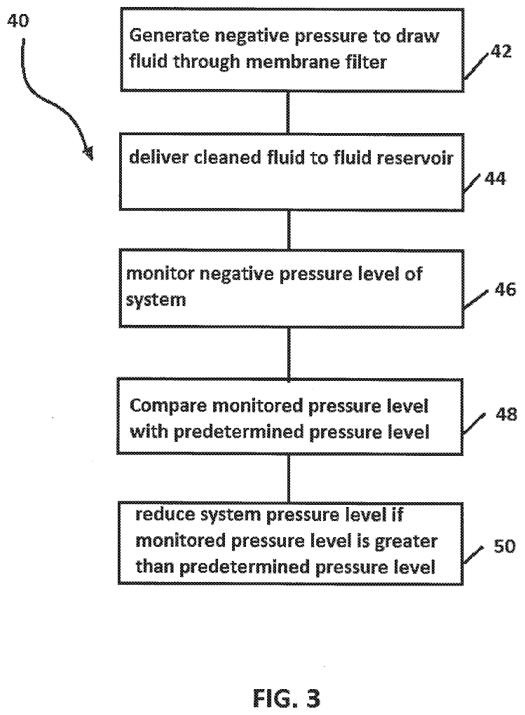

Referring to FIG. 3, a method 40 of controlling a fluid filtration system in accordance with an embodiment of the present disclosure is depicted.

In step 42, a negative pressure is generated to draw the raw fluid to be treated through the filtration membrane to generate clean fluid. As for each for the embodiments described above, a pump is employed to generate this negative pressure with the pump being connected to the membrane by a pipe to define a suction means.

In step 44, the cleaned fluid that is drawn through the filtration membrane is delivered downstream of the pump to a fluid reservoir that stores the cleaned fluid.

In step 46, the negative pressure level of the system is monitored, typically through the use of dedicated pressure sensors placed in the suction line to monitor the negative pressure levels being experienced by the membranes and/or the pump. This level may be processed by a dedicated computer controller, such as that described above in relation to the earlier embodiments.

In step 48, the controller may compare the monitored pressure levels received from the pressure level sensors for the system against a predetermined pressure level stored with respect to the controller. The predetermined pressure level may be determined as the maximum working pressure level for the pump and/or the membranes to operate under without causing damage to the pump and/or membranes. This level may be dependent upon the conditions of the system and can be set and re-set as required.

In step 50, the controller determines that when the measured pressure level is at or exceeds the predetermined pressure level, action is initiated to reduce the system pressure level. This can be in the form of the controller reducing the speed or throughput of the pump to reduce the negative pressure levels generated and/or connecting the pump to the cleaned fluid reservoir to freely pump the already treated water so as to minimise pressure levels in the system until such time as a membrane cleaning event is initiated.

It will be appreciated that by enabling recirculation of cleaned water into the pump upon triggering of a predetermined system pressure or by controlling the operation of the pump in accordance with system operating pressure, the system is always able to operate at an optimal pressure to maximise the life of the membrane. This ensures that the pump is not overloaded and that the negative pressure at the membrane(s) is maintained within acceptable limits to minimise damage to the membranes as a result of over-pressurisation of the membrane. The system of the present disclosure thereby maximizes efficiency of the various components and maximises the working life of the components.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the disclosure described herein without departing from the spirit and scope of the disclosure.

1. A membrane filtration system comprising:
a supply tank for receiving a supply of raw fluid for filtration;
a membrane filter at least partially submerged within the raw fluid;
a suction line attachable to the membrane filter for drawing the raw fluid from the supply tank through the membrane filter and to a storage reservoir for storage as cleaned fluid;
a pump for supplying a negative pressure to the suction line for drawing the raw fluid through the membrane filter to the storage reservoir; and
wherein, the negative pressure present in the suction line is monitored and controlled so as to be maintained between acceptable operating limits.

2. The membrane filtration system according to claim 1, wherein the negative pressure in the suction line is monitored by way of a pressure sensor mounted with respect to the membrane filter.

3. The membrane filtration system according to claim 2, wherein the pressure sensor measures a negative fluid pressure at the membrane filter.

4. The membrane filtration system according to claim 3, wherein the negative fluid pressure is controlled by a controller mounted with respect to the pump.

5. The membrane filtration system according to claim 4, wherein the controller receives and processes the negative fluid pressure measured by the pressure sensor and controls throughput of the pump to maintain the negative fluid pressure measured by the pressure sensor at or below an upper pressure limit.

6. The membrane filtration system according to claim 5, wherein the controller controls the throughput of the pump by controlling a variable speed drive or throttle of the pump.

7. The membrane filtration system according to claim 6, wherein the controller controls the variable speed drive or throttle of the pump to speed up or slow down the pump in accordance with the negative fluid pressure measured by the pressure sensor.

8. A membrane filtration system comprising:
a supply tank for receiving a supply of raw fluid for filtration;
a membrane filter at least partially submerged within the raw fluid;
a suction line attachable to the membrane filter for drawing cleaned fluid from the membrane filter to a storage reservoir for storing the cleaned fluid;
a pump located within the suction line for supplying a negative pressure to the suction line for delivering said cleaned fluid from the membrane filter to the storage reservoir;
a bypass line connecting the suction line to the storage reservoir so as to bypass passage of the fluid through the pump; and
a pressure regulating valve located within said bypass line,
wherein, upon a negative pressure level, being present in the suction line, reaching a predetermined level, the pressure regulating valve opens to connect the suction line with the storage reservoir.

9. The membrane filtration system according to claim 8, further comprising a controller that controls a state of the pressure regulating valve between an open state and a closed state.

10. The membrane filter according to claim 9, wherein the controller comprises one or more pressure sensors located in the suction line for measuring the negative pressure level within the suction line.

11. The membrane filter according to claim 10, wherein the controller compares the negative pressure level received from the one or more pressure sensors against the predetermined pressure level, and if the negative pressure level is at or above the predetermined pressure level, the controller causes the pressure regulating valve to move to an open state to facilitate flow of cleaned fluid from the storage reservoir into the suction line, thereby reducing the negative pressure level within the suction line.

12. A method of controlling a membrane filtration system to limit working pressures acting on a pump and membranes thereof comprising:
generating a negative pressure to draw fluid from a raw fluid source through the membranes of a membrane filter to generate cleaned fluid;
delivering said cleaned fluid to a storage reservoir for storage;
monitoring a level of the negative pressure generated;
comparing said monitored level of negative pressure against a predetermined level of negative pressure; and
if the monitored level of negative pressure is the same as or greater than the predetermined level of negative pressure, reducing the negative pressure level of the system to be at or below the predetermined level of negative pressure.

13. A method according to claim 12, wherein the step of generating the negative pressure comprises operating a pump to generate the negative pressure required to draw the raw fluid through the membranes of the membrane filter.

14. A method according to claim 13, wherein the step of reducing the negative pressure level of the system comprises controlling throughput of the pump to maintain the monitored level of the negative pressure at or below the predetermined level of negative pressure.

15. A method according to claim 13, wherein the step of reducing the negative pressure level of the system comprises connecting the pump to a bypass line in fluid communication with the cleaned fluid in the storage reservoir to maintain the monitored level of the negative pressure at or below the predetermined level of negative pressure.
